(19) United States
(12) Patent Application Publication
(10) Pub. No.: US 2008/0246751 A1
(43) Pub. Date: Oct. 9, 2008

(54) POWER FACTOR CORRECTOR

(76) Inventor: Il-Woon LEE, Suwon-si (KR)

Correspondence Address: CHRISTIE, PARKER & HALE, LLP, PO BOX 7068, PASADENA, CA, 91109-7068, US

(21) Appl. No.: 11/967,825

(22) Filed: Dec. 31, 2007

(30) Foreign Application Priority Data
Apr. 6, 2007 (KR) 10-2007-0034146

(51) Int. Cl. G09G 5/00; G05F 1/70

(52) U.S. Cl. 345/212; 323/205; 345/60

(57) ABSTRACT

A power factor correction circuit (PFC) including a switch, a feedback signal generator for generating a feedback voltage corresponding to an output voltage, and a switching controller for receiving the feedback voltage and for controlling turn-on/turn-off of the switch. The feedback signal generator includes first and second resistors serially connected to first and second ends of an PFC output terminal; a first capacitor connected between a first node of the first and second resistors and the first end of the PFC output terminal; and a comparator for comparing a voltage of the first node and a reference voltage, and for generating a feedback voltage.

### CROSS-REFERENCE TO RELATED APPLICATION

This application claims priority to and the benefit of Korean Patent Application No. 10-2007-0034146 filed in the Korean Intellectual Property Office on Apr. 6, 2007, the entire contents of which are incorporated herein by reference.

### BACKGROUND OF THE INVENTION

1. Field of the Invention

The present invention relates to a power factor correction circuit. More particularly, the present invention relates to a power factor correction circuit included in a power supply that prevents a sudden increase of an output voltage by realizing a quick response speed to fluctuation of an input voltage.

2. Description of the Related Art

The plasma display device is a display device for displaying characters or images by using plasma generated according to a gas discharge, in which discharge cells are arranged in a matrix form according to its size. The plasma display device can be classified into a DC plasma display device or an AC plasma display device depending on driving voltage waveforms and a structure of discharge cells.

In a panel of the DC plasma display device, electrodes are exposed to a discharge space, so current is directly coupled to the discharge space while voltage is being applied, and thus resistors are needed to limit the current. In a panel of the AC plasma display device, electrodes are covered by a dielectric layer, naturally forming a capacitance component to limit current and protecting the electrodes from an impact of ions during a discharge, so its life span is longer than that of the DC plasma display device.

The plasma display device includes a power supply for providing various high voltages (i.e., a sustain discharge voltage Vs, an address voltage Va, a reset voltage Vset, a scan voltage, etc., required for a plasma discharge) to driving circuits, and low voltages to other circuits, namely, an image processing unit, a fan, an audio unit, and a control circuit unit, etc.

In general, a power supply includes a power factor correction (PFC) circuit that corrects a power factor of an external input voltage by controlling an input current to follow an external input voltage and converts an alternating current (AC) voltage to a direct current (DC) voltage. Typically, the power supply of the plasma display device uses a boost PFC circuit.

In a typical boost PFC circuit, a zero component exists in a right half portion of the Bode plot when analyzing a small signal, and therefore, the typical boost PFC circuit has a slow response speed for an input voltage change due to a narrow bandwidth. Thus, when the boost PFC circuit is suddenly turned off and then an input voltage is re-supplied, an input voltage fluctuation occurs so that an output voltage is suddenly increased. A high-frequency noise generated due to the sudden increase of the output voltage causes a stress to other circuit elements in the power supply that receives the output voltage of the boost PFC circuit, thereby causing operational errors or damage to the circuit elements.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of the present invention is directed toward an effort to provide a power factor correction (PFC) circuit that can prevent or reduce a sudden increase of an output voltage of the PFC circuit due to a sudden fluctuation of an input voltage to the PFC circuit.

An exemplary PFC circuit according to one embodiment of the present invention outputs an output voltage generated by power factor correcting a voltage input to an PFC input terminal by operation of a switch through a PFC output terminal. The PFC circuit includes a feedback signal generator and a switching controller. The feedback signal generator generates a feedback voltage corresponding to the output voltage. The switching controller receives the feedback voltage and controls turn-on/turn-off of the switch. The feedback signal generator includes first and second resistors, a first capacitor, and a comparator. The first and second resistors are connected in series to first and second ends of the PFC output terminal. The first capacitor is connected between a first node of the first and second resistors and a first end of the PFC output terminal. The comparator compares a voltage of the first node and a reference voltage and generates a feedback voltage.

An exemplary plasma display device according to another embodiment of the present invention includes a plurality of first electrodes, a plurality of second electrodes, and a plurality of third electrodes crossing the first and second electrodes; a driving circuit unit for driving the first, second, and third electrodes; and a power supply for generating a plurality of power source voltages required for driving the driving circuit unit. The power supply includes a PFC circuit for outputting an output voltage generated by power factor correcting a voltage input to a PFC input terminal by an operation of a switch through a PFC output terminal, and a voltage generator for generating the plurality of power source voltages by converting the output voltage. The PFC circuit includes a feedback signal generator for generating a feedback voltage corresponding to the output voltage, and a switching controller for receiving the feedback voltage and for controlling turn-on/turn-off of the switch. The feedback signal generator includes first and second resistors connected in series to first and second ends of the PFC output terminal; a first capacitor connected between a first node of the first and second resistors and the first end of the PFC output terminal; and a comparator for comparing a voltage of the first node and a reference voltage, and for generating a feedback voltage.

### BRIEF DESCRIPTION OF THE DRAWINGS

FIG. 1 shows a power supply according to an exemplary embodiment of the present invention.

FIG. 2 shows a feedback signal generator according to the exemplary embodiment of the present invention.

FIG. 3 shows transfer functions of Equation 1 and Equation 2 in a Bode plot.

FIG. 4 shows an output voltage of a typical boost power factor correction (PFC) circuit that corresponds to an increase of a dip period and an output voltage of a boost PFC circuit that corresponds to the same increase of the dip period according to the exemplary embodiment of the present invention.

FIG. 5 shows an output voltage detector according to another exemplary embodiment of the present invention.

FIG. 6 shows transfer functions of Equation 1 and Equation 3 in a Bode plot.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that a first element is “coupled” to a second element, the first element may be “directly coupled” to the second element or “electrically coupled” to the second element through a third element. In addition, unless explicitly described to the contrary, the word “comprise” and variations such as “comprises” and “comprising” will be understood to imply the inclusion of stated elements but not the exclusion of any other elements.

When it is described in the specification that a voltage is maintained, it should be understood that the voltage does not have to be maintained exactly at a voltage that may be predetermined. To the contrary, even if a voltage difference between two points varies, the voltage difference is expressed to be maintained at a voltage that may be predetermined in the case that the variance is within a range allowed in design constraints or in the case that the variance is caused due to a parasitic component that is usually disregarded. In addition, since threshold voltages of semiconductor elements (e.g., a transistor and a diode) are very low compared to a discharge voltage, they are considered to be 0 V.

A power factor correction (PFC) circuit according to an exemplary embodiment of the present invention will now be described in more detail with reference to the accompanying drawings.

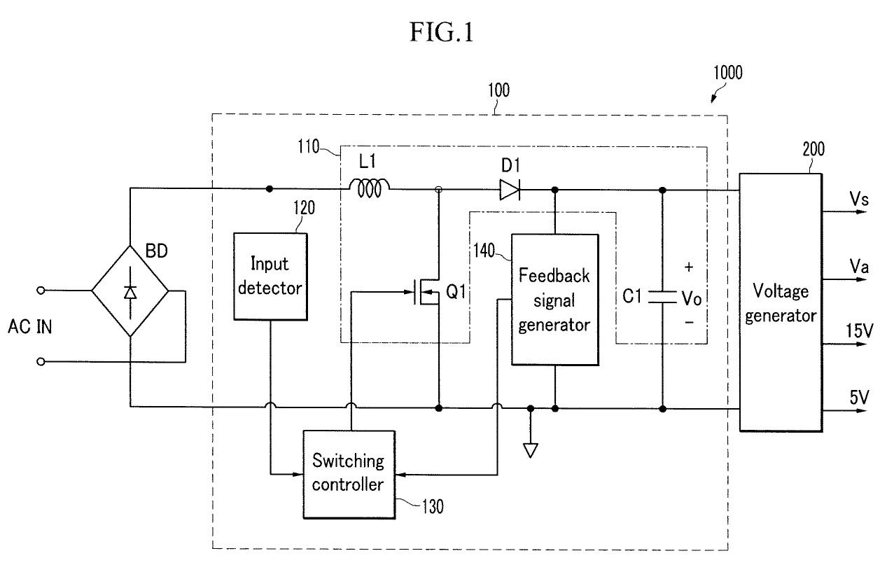

FIG. 1 shows a power supply 1000 according to an exemplary embodiment of the present invention.

As shown in FIG. 1, the power supply 1000 includes a boost PFC circuit 100 and a voltage generator 200.

The boost PFC circuit 100 receives a voltage rectified by a bridge diode (BD) and outputs an output voltage Vo, and the voltage generator 200 receives the output voltage Vo from the boost PFC circuit 100 and outputs a plurality of direct current (DC) voltages Vs, Va, 15V, and 5V by using a DC-DC converter. Here, the plurality of DC voltages Vs, Va, 15V, and 5V output from the voltage generator 200 are used for driving a plasma display device.

Hereinafter, the boost PFC circuit 100 will be described in more detail with reference to FIG. 1.

The boost PFC circuit 100 includes a boost circuit 110 formed of an inductor L1, a switch Q1, a diode D1, and a capacitor C1; an input detector 120; a switching controller 130; and a feedback signal generator 140. Hereinafter, the inductor L1, the switch Q1, the diode D1, and the capacitor C1 are set to be included in the boost circuit 110 for convenience of description.

In the boost circuit 110, a first end of the inductor L1 is connected to an output of the bridge diode BD, and a second end of the inductor L1 is connected to an anode of the diode D1. A cathode of the diode D1 is connected to a first end of the capacitor C1, and a second end of the capacitor C1 is connected to a ground. A drain terminal of the switch Q1 is connected to a node of the inductor L1 and the anode of the diode D1, a source terminal of the switch Q1 is connected to the second end of the capacitor C1, and a gate terminal of the switch Q1 is connected to an output terminal of the switching controller 130. Although the switch Q1 is illustrated as a MOSFET in FIG. 1, this is not restrictive. A bipolar transistor or another switching element can also be used as the switch Q1.

The input detector 120 detects a root mean square value Vrms of an input voltage (that has been rectified by the bridge diode BD and input to the boost circuit 110) and a root mean square value Irms of an input current, and outputs the detected values to the switching controller 130. Here, the root mean square value Vrms of the input voltage and the root mean square value Irms of the input current are detected by suitable methods.

The switching controller 130 receives the output voltage Vo of the boost circuit 110, the root mean square values Vrms and Irms of the input voltage, and the input current output from the input detector 120; and the switching controller 130 outputs a control signal that controls turning on/off of the switch Q1.

The feedback signal generator 140 generates a feedback signal Vfb corresponding to the output voltage Vo of the boost circuit 110 and outputs the feedback signal Vfb to the switching controller 130.

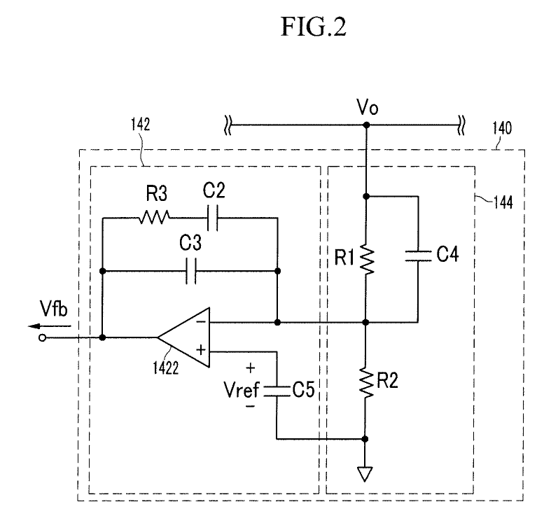

The feedback signal generator 140 according to the exemplary embodiment of the present invention will be described in more detail with reference to FIG. 2.

FIG. 2 shows the feedback signal generator 140 according to the exemplary embodiment of the present invention.

As shown in FIG. 2, the feedback signal generator 140 includes an integrator 142 and an output voltage detector 144.

The integrator 142 includes an error amplifier 1422, a resistor R3, and capacitors C2, C3, and C5.

A first end of the capacitor C2 is connected to an inverting input terminal (−) of the error amplifier 1422. The resistor R3 has a first end connected to a second end of the capacitor C2 and a second end connected to an output terminal of the error amplifier 1422. The capacitor C3 has a first end connected to the first end of the capacitor C2 and a second end connected to the second end of the resistor R3. The capacitor C5 is connected between the non-inverting input terminal (+) of the error amplifier 1422 and the ground terminal.

The error amplifier 1422 compares a reference voltage Vref supplied from the capacitor C5 through the non-inverting input terminal (+) and an output signal of the output voltage detector 144 input through an inverting input terminal (−), generates a feedback signal Vfb, and outputs the feedback signal Vfb to the switching controller (130 of FIG. 1).

The output voltage detector 144 includes resistors R1 and R2 and a capacitor C4.

The resistor R1 has a first end connected to a node between the diode D1 of the boost circuit (110 of FIG. 1) and the capacitor C1 and a second end connected to the inverting terminal (−) of the error amplifier 1422. The resistor R2 has a first end connected to the second end of the resistor R1 and a second end connected to the ground terminal. The capacitor C4 is connected between the first end and the second end of the resistor R1.

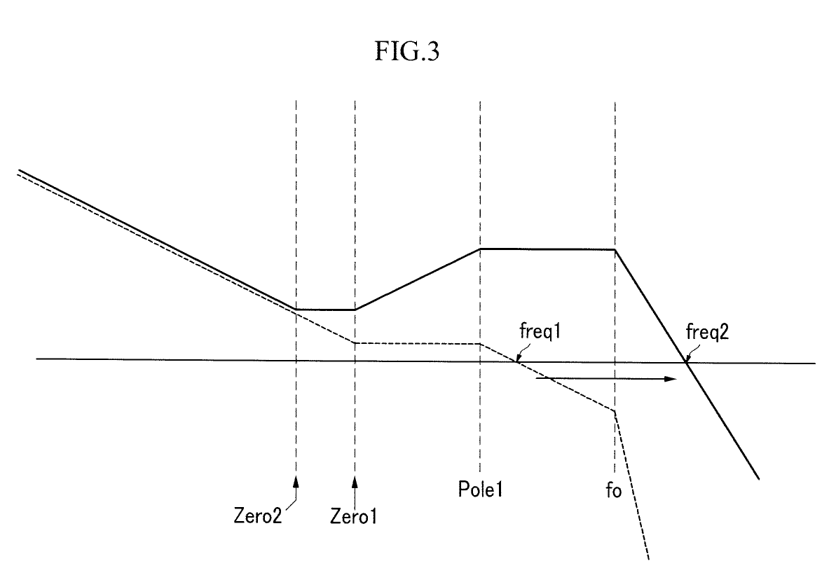

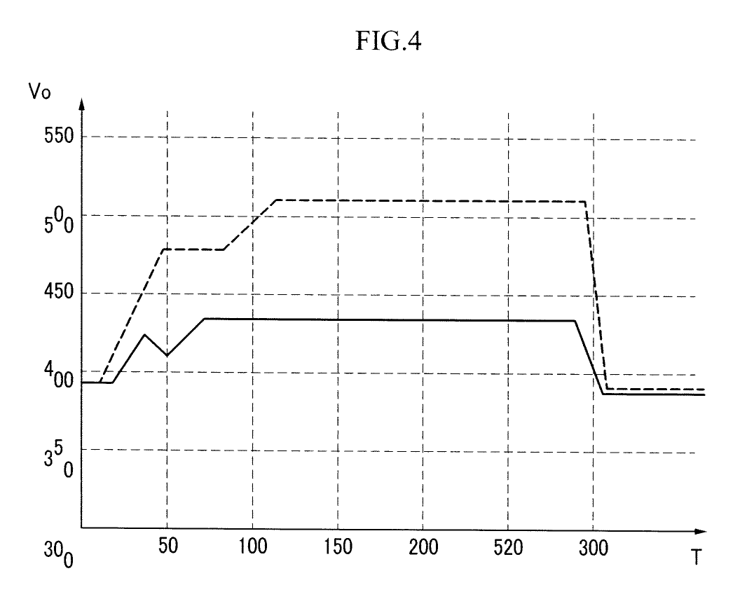

As shown, the output voltage detector 144 included in the feedback signal generator 140 of FIG. 2 includes the capacitor C4, as opposed to an output voltage detector of a typical feedback signal generator. Hereinafter, a gain of an error amplifier included in a typical feedback signal generator will be compared with a gain of the feedback signal generator 140 according to the exemplary embodiment of the present invention by using a transfer function. In addition, variation of an output voltage of the typical boost PFC circuit and the output voltage Vo of the boost PFC circuit 100 of the present embodiment according to variation of the transfer function will be described with reference to FIG. 3 and FIG. 4. Here, the transfer function is a function that denotes a ratio of an output signal corresponding to an input signal after Laplace transforming the output voltage Vo of the boost PFC circuit and a feedback signal Vfb, which is an output signal of the feedback signal generator 140.

Equation 1 shows a gain of the typical feedback signal generator by using the transfer function. In the following description, Laplace transformed values of the output voltage Vo of the boost PFC circuit and the output signal (i.e., feedback signal Vfb) of the feedback signal generator will be denoted as Vo(S) and Vfb(S), respectively.

$$\frac{V f b ( S )}{V o ( S )} = - \frac{1}{s ( C 2 + C 3 ) R 1} \times \frac{1 + s C 2 R 3}{1 + s [ C 2 C 3 / ( C 2 + C 3 ) ] R 3} \qquad Equation 1$$

Equation 2 shows a gain of the feedback signal generator 140 according to the exemplary embodiment of the present invention by using the transfer function.

$$\frac{V f b ( S )}{V o ( S )} = - \frac{1}{s ( C 2 + C 3 ) R 1} \times \frac{( 1 + s C 2 R 3 ) ( 1 + s C 4 R 1 )}{1 + s [ C 2 C 3 / ( C 2 + C 3 ) ] R 3} \qquad Equation 2$$

When representing the transfer functions of Equation 1 and Equation 2 in the Bode plot, a cut-off frequency of the integrator 142 that commonly corresponds to the transfer functions of Equation 1 and Equation 2 is 1/[2π*(C2+C3)R1]Hz, and a pole frequency is (C2+C3)/(2π*C2C3R3)Hz. A zero frequency that corresponds to the transfer function of Equation 1 is (2π*C2R3)Hz (i.e. one zero), and a zero frequency that corresponds to the transfer function of Equation 2 is 1/(2π*C2R3)Hz and 1/(2π*C4R1)Hz (i.e., two zeros), and this is shown in FIG. 3.

FIG. 3 shows the transfer functions of Equation 1 and Equation 2 in the Bode plot. In FIG. 3, the transfer function of Equation 1 is shown as a dotted line, and the transfer function of Equation 2 is shown as a solid line. In addition, in the feedback signal generator 140 of FIG. 2 according to the exemplary embodiment of the present invention, a value obtained by multiplying capacitance of the capacitor C2 by resistance of the resistor R1 is set to be greater than a value obtained by multiplying capacitance of the capacitor C2 by resistance of the resistor R3. Therefore, a location of the zero that corresponds to the transfer function of Equation 2 is further to left on the left-half portion of the Bode plot as compared to the zero that corresponds to the transfer function of Equation 1, as shown in FIG. 3.

The Bode plot corresponding to the transfer function of Equation 1 will now be described.

The transfer function of Equation 1 has a negative slope of 20 dB/dec by the integrator 142 having a cut off frequency of 1/[2π*(C2+C3)R1]Hz as frequency increases, and the slope becomes 0 dB/dec when the transfer function reaches a zero (Zero1 of FIG. 3) of 1/(2π*C2R3)Hz. Then, when the transfer function reaches a pole of (C2+C3)/(2π*C2C3R3)Hz, the slope is reduced by 20 dB/dec, and when the transfer function reaches a double pole (fo of FIG. 3) due to cut-off frequency of the inductor L1 and the capacitor C1 of the boost PFC circuit (110 of FIG. 1), −40 dB/dec is added to the slope so that the slope is decreased to 60 dB/dec.

The Bode plot of the transfer function of Equation 2 will now be described.

The transfer function of Equation 2 has a negative slope of 20 dB/dec due to the integrator 142 having a cut-off frequency of 1/[2π*(C2+C3)R1]Hz in the feedback circuit, and the slope becomes 0 dB/dec when the transfer function reaches a zero (Zero2 of FIG. 3) of 1/(2π*C4R1)Hz. Then, when the transfer function reaches the zero (Zero1 of FIG. 3) of 1/(2π*C2R3)Hz, the slope is increased by 20 dB/dec, and when the transfer function reaches a pole (Pole1 of FIG. 3) of (C2+C3)/(2π*C2C3R3)Hz, the slope becomes 0 dB/dec. In addition, when the transfer function reaches the double pole (fo of FIG. 3) due to cut off frequency of the inductor L1 and the capacitor C1 of the boost PFC circuit (110 of FIG. 1), the slope is decreased by 40 dB/dec.

The frequencies freq1 and freq2 that make the size of each transfer function of Equation 1 and Equation 2 to be zero correspond to a bandwidth of the feedback signal generator. That is, as the frequency that makes the size of the transfer function to be zero is increased, the bandwidth is increased. As shown in FIG. 3, the frequency freq1 that makes the size of the transfer function of Equation 1 to be zero is less than the frequency freq2 that makes the transfer function of Equation 2 to be zero. This implies that a bandwidth of the feedback signal generator 140 according to the exemplary embodiment of the present invention is greater than a bandwidth of the feedback signal generator included in the typical boost PFC. Therefore, the feedback signal generator 140 according to the exemplary embodiment of the present invention can output a stable output voltage by more quickly responding to a sudden fluctuation of an output voltage due to a rapid fluctuation of an input voltage than the feedback signal generator included in the typical boost PFC.

Hereinafter, fluctuations in an output voltage of the boost PFC circuit 100 according to the exemplary embodiment of the present invention and an output voltage of the typical boost PFC circuit will be described in more detail with reference to FIG. 4.

FIG. 4 shows peak values of the typical boost PFC circuit that correspond to an increase of a dip period and the boost PFC circuit 100 according to the first exemplary embodiment of the present invention. Here, the dip period refers to a period during which an input voltage input to a boost PFC circuit during normal operation of the boost PFC circuit is instantly dropped to a 0 V voltage and is maintained at the 0 V voltage. In addition, FIG. 4 shows a value measured by repeating instantly increasing the input voltage of the boost PFC circuit to a voltage applied to the boost PFC circuit in normal operation after the dip period. In FIG. 4, the output voltage of the typical boost PFC circuit is represented as a dotted line, and the output voltage Vo of the boost PFC circuit 100 according to the exemplary embodiment of the present invention is represented as a solid line.

As shown in FIG. 4, a peak value of the output voltage of the typical boost PFC circuit exceeds 500V due to a sudden fluctuation of the input voltage, whereas a peak value of the output voltage of the boost PFC circuit 100 according to the exemplary embodiment of the present invention is less than the peak value of the typical boost PFC circuit under the same condition.

As shown in FIG. 4, the boost PFC circuit 100 according to the exemplary embodiment of the present invention suppresses a sudden increase of the output voltage, and accordingly circuit elements of the boost PFC circuit 100 can be prevented from operational errors or damage, unlike the typical boost PFC.

The input voltage of the feedback signal generator 140 according to the exemplary embodiment of the present invention is suddenly fluctuated and is affected by the zero (Zero2 of FIG. 3) that is added to 1/(2π*C4R1, Hz) even though the input voltage is stably supplied to the feedback signal generator 140, and therefore the capacitance of the capacitor C4 must be precisely set. When an error occurs in setting the capacitance of the capacitor C4 and thus the capacitance is not within an allowable range, the boost PFC circuit 100 according to the present invention may be unstably driven or may become sensitive to noise.

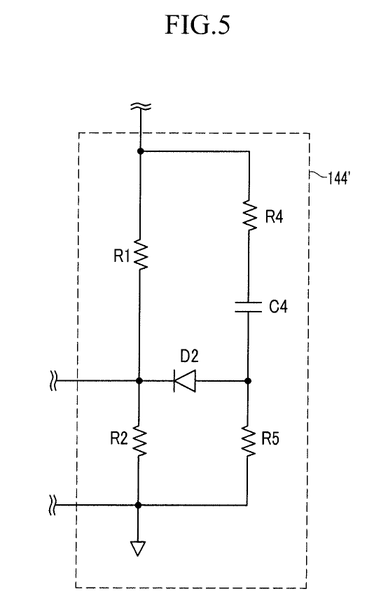

An output voltage detector 144′ that controls a current to flow through the capacitor C4 only when the input voltage of the feedback signal generator 140 is suddenly fluctuated so as to stably drive the boost PFC circuit 100 according to another exemplary embodiment of the present invention will be described in further detail with reference to FIG. 5.

FIG. 5 shows the output voltage detector 144′ according to the another exemplary embodiment of the present invention.

As shown in FIG. 5, the output voltage detector 144′ further includes resistors R4 and R5 and a diode D2 in addition to the constituent elements of the output voltage detector 144.

The resistor R4 has a first end connected between a first end of the capacitor C4 and the first end of the resistor R1, and the resistor R5 is connected between a second end of the capacitor C4 and the ground end. The diode D2 has an anode connected to a node of the capacitor C4 and the resistor R5, and a cathode connected to a node of the resistor R1 and the resistor R2.

The output voltage detector 144′ of FIG. 5 operates differently according to a fluctuation speed of an input voltage input to the boost PFC circuit 100. That is, when the input voltage of the boost PFC circuit 100 is stably maintained within a level that may be predetermined so that no sudden fluctuation of an output voltage Vo occurs, a voltage of the anode of the diode D2 becomes less than a voltage of the cathode due to high impedance at the lateral ends of the capacitor C4. That is, when the input voltage of the boost PFC circuit 100 is stably maintained within the level (or predetermined level), the amount of current flowing through the resistors R4 and R5, the capacitor C4, and the diode D2 of the output voltage detector 144′ becomes zero. Therefore, when the input voltage of the boost PFC circuit 100 is stably maintained within the level (or predetermined level), a gain of the feedback signal generator 140 becomes equal to a gain of the typical feedback signal generator, and the transfer function becomes the same as Equation 1.

When the input voltage of the boost PFC circuit 100 is suddenly fluctuated, the output voltage Vo of the boost PFC circuit 100 is also suddenly fluctuated. Accordingly, the impedance at the lateral ends of the capacitor C4 is decreased, and the voltage of the anode of the diode D2 becomes greater than the voltage of the cathode. That is, only when the input voltage of the boost PFC circuit 100 is suddenly fluctuated does the current flow through the resistors R4 and R5, the capacitor C4, and the diode D2 of the output voltage detector 144′, according to the exemplary embodiment of the present invention. In this case, the gain of the feedback signal generator 140 that includes the output voltage detector 144′ according to the exemplary embodiment of the present invention is shown in Equation 3.

$$\frac{V f b ( S )}{V o ( S )} = - \frac{1}{s ( C 2 + C 3 ) R 1} \times \frac{( 1 + s C 2 R 3 ) ( 1 + s C 4 R 1 )}{[ 1 + s \{ C 2 C 3 / ( C 2 + C 3 ) \} R 3 ] * ( 1 + s C 4 R 4 )} \qquad Equation 3$$

When the transfer function of Equation 3 is represented in the Bode plot, a cut-off frequency of the integrator 142 is 1/[2π*(C2+C3)R1]Hz, which is the same as the cut-off frequency of Equation 1 and Equation 2. However, a pole frequency corresponding to the transfer function of Equation 3 is (C2+C3)/(2π*C2C3R3)Hz and 1/(2π*C4R4)Hz, and a zero frequency is 1/(2π*C2R3)Hz and 1/(2π*C4R1)Hz. That is, there exist two poles and two zeros.

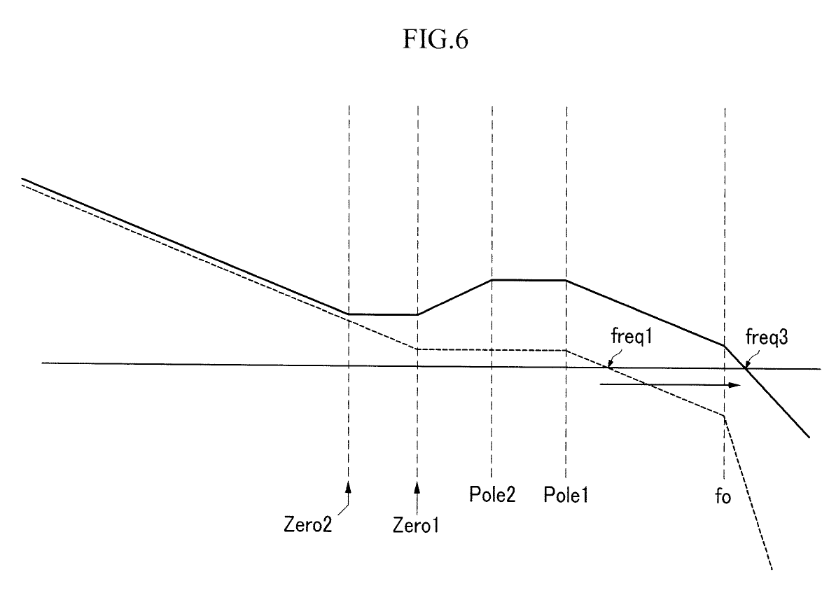

FIG. 6 shows the transfer functions of Equation 1 and Equation 3 in the Bode plot. In FIG. 6, the transfer function of Equation 1 is shown as a dotted line, and the transfer function of Equation 3 is shown as a solid line. In addition, a value obtained by multiplying the capacitance of the capacitor C4 and the resistance of the resistor R4 of the output voltage detector 144′ of FIG. 5 according to the exemplary embodiment of the present invention is set to be less than a value obtained by multiplying the capacitance of the capacitor C2 by the resistance of the resistor R3, and is set to be greater than a value obtained by dividing a value obtained by multiplying the capacitances of the capacitors C2 and C3 by the resistance of the resistor R3 by a value obtained by adding the capacitance of the capacitor C2 and the capacitance of the capacitor C3.

The size of the transfer function of Equation 3 has a negative slope of 20 dB/dec due to the integrator 142 having a cut-off frequency of 1/[2π*(C2+C3)R1]Hz, and the slope becomes 0 dB/dec when the size of the transfer function reaches a zero (Zero2 of FIG. 6) of 1/(2π*C4R1)Hz. After that, when the size of the transfer function reaches a zero (Zero1 of FIG. 6) of 1/(2π*C2R3)Hz, the slope is increased by 20 dB/dec, and the slope becomes 0 dB/dec as the size of the transfer function reaches a pole (Pole2 of FIG. 6) of 1/(2π*C4R4)Hz. In addition, as the size of the transfer function reaches a pole (Pole1 of FIG. 6) of (C2+C3)/(2π*C2C3R3)Hz, the slope is decreased by 20 dB/dec. Further, when the size of the transfer function reaches the double pole (fo of FIG. 6) due to the cut-off frequency of the inductor L1 and the capacitor C1 in the boost circuit (110 of FIG. 1), the slope is added with −40 dB/dec so that the slope is decreased to 60 dB/dec.

The frequency freq1 that makes the size of the transfer function of Equation 1 to be zero is lower than the frequency freq3 that makes the transfer function of Equation 3 to be zero. That is, the feedback signal generator 140 according to the exemplary embodiment of the present invention has a wider bandwidth when the input voltage of the boost PFC circuit 100 is suddenly fluctuated than when the input voltage of the boost PFC circuit 100 is stable.

In this case, the frequency freq3 that makes the size of the transfer function of Equation 3 to be zero is similar to the frequency freq2 that makes the size of the transfer function of Equation 2 to be zero. Therefore, when the input voltage is suddenly fluctuated, the peak value of the output voltage of the boost PFC circuit 100 that includes the output voltage detector 144′ according to the present exemplary embodiment of the present invention is similar to the peak value of the output voltage of the boost PFC circuit 100 that includes the output voltage detector 144 of FIG. 4.

The boost PFC circuit 100 including the output voltage detector 144′ increases the bandwidth of the input voltage only when the output voltage of the boost PFC circuit 100 is suddenly fluctuated due to the sudden fluctuation of the input voltage so as to quickly respond to the sudden fluctuation of the output voltage, thereby stably realizing the output voltage. The boost PFC circuit 100 including the output voltage detector 144′ is driven the same (or substantially the same) as the typical boost PFC circuit when the input voltage is stable, and therefore the boost PFC circuit 100 does not cause a problem due to unstable driving or noise.

The boost PFC circuit 100 increases the width of the bandwidths of the output voltage detectors 144 and 144′ so as to quickly respond to fluctuation of the input voltage, thereby preventing or reducing a sudden increase of the output voltage. Accordingly, circuit electrodes can be protected from erroneous operation or damage, thereby realizing the stable driving power supply 1000.

The boost PFC circuit 100 can be used in a power supply of a display device including a plasma display device or a liquid crystal display (LCD), or in a typical power supply.

As described above, according to an exemplary embodiment of the present invention, the boost PFC circuit has increased bandwidth in order to quickly respond to input voltage fluctuation so that a sudden increase of an output voltage from the boost PFC circuit can be prevented (or reduced) even though the input voltage is suddenly increased.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A power factor correction (PFC) circuit for outputting an output voltage, generated by power factor correcting a voltage input to a PFC input terminal by an operation of a switch, through a PFC output terminal, the PFC circuit comprising:
a feedback signal generator for generating a feedback voltage corresponding to the output voltage; and
a switching controller for receiving the feedback voltage, and for controlling turn-on/turn-off of the switch,
wherein the feedback signal generator comprises
first and second resistors connected in series to first and second ends of the PFC output terminal,
a first capacitor connected between a first node of the first and second resistors and the first end of the PFC output terminal, and
a comparator for comparing a voltage of the first node and a reference voltage, and for generating a feedback voltage.

2. The PFC circuit of claim 1, further comprising:
a second capacitor connected to the first node and a comparator output terminal of the comparator;
a third capacitor having a first end connected to the first node; and
a third resistor having a first end connected to a second end of the third capacitor and a second end connected to the comparator output terminal.

3. The PFC circuit of claim 2, wherein a first value obtained by multiplying a capacitance of the first capacitor and a resistance of the first resistor is greater than a second value obtained by multiplying a capacitance of the third capacitor by a resistance of the third resistor.

4. The PFC circuit of claim 3, further comprising:
a fourth resistor connected between the first end of the PFC output terminal and a first end of the first capacitor;
a diode having an anode connected to the second end of the first capacitor and a cathode connected to the first node; and
a fifth resistor connected between the second end of the first capacitor and the second end of the PFC output terminal.

5. The PFC circuit of claim 4, wherein a third value obtained by multiplying the capacitance of the first capacitor by a resistance of the fourth resistor is less than the second value.

6. The PFC circuit of claim 5, wherein a sixth value obtained by dividing a fourth value, obtained by multiplying a capacitance of the second capacitor and the capacitance of the third capacitor by the resistance of the third resistor, with a fifth value obtained by adding the capacitance of the second capacitor and the capacitance of the third capacitor, is less than the third value.

7. A plasma display device comprising:
a plurality of first electrodes, a plurality of second electrodes, and a plurality of third electrodes crossing the first and second electrodes;
a driving circuit unit for driving the first, second, and third electrodes; and
a power supply for generating a plurality of power source voltages required for driving the driving circuit unit,
wherein the power supply comprises:
a power factor correction (PFC) circuit for outputting an output voltage, generated by power factor correcting a voltage input to an PFC input terminal by an operation of a switch, through an PFC output terminal; and
a voltage generator for generating the plurality of power source voltages by converting the output voltage,
wherein the power factor correction circuit comprises:
a feedback signal generator for generating a feedback voltage corresponding to the output voltage; and
a switching controller for receiving the feedback voltage and controlling turn-on/turn-off of the switch,
wherein the feedback signal generator comprises
first and second resistors connected in series to first and second ends of the PFC output terminal,
a first capacitor connected between a first node of the first and second resistors and the first end of the PFC output terminal, and
a comparator for comparing a voltage of the first node and a reference voltage, and for generating a feedback voltage.

8. The plasma display device of claim 7, further comprising:
a second capacitor connected to the first node and a comparator output terminal of the comparator;
a third capacitor having a first end connected to the first node; and
a third resistor having a first end connected to a second end of the third capacitor and a second end connected to the comparator output terminal.

9. The plasma display device of claim 8, wherein a first value obtained by multiplying a capacitance of the first capacitor and a resistance of the first resistor is greater than a second value obtained by multiplying a capacitance of the third capacitor by a resistance of the third resistor.

10. The plasma display device of claim 8, wherein the PFC circuit further comprising:
a fourth resistor connected between the first end of the PFC output terminal and a first end of the first capacitor;
a diode having an anode connected to a second end of the first capacitor and a cathode connected to the first node;
a fifth resistor connected between the second end of the first capacitor and the second end of the PFC output terminal; and
a comparator for comparing a voltage of the first node and a reference voltage and generating a feedback voltage.

11. The plasma display device of claim 10, wherein a third value obtained by multiplying the capacitance of the first capacitor by a resistance of the fourth resistor is less than a second value obtained by multiplying the capacitance of the third capacitor by the resistance of the third resistor.

12. The plasma display device of claim 11, wherein a sixth value that is obtained by dividing a fourth value, obtained by multiplying a capacitance of the second capacitor and the capacitance of the third capacitor by the resistance of the third resistor, with a fifth value obtained by adding the capacitance of the second capacitor and the capacitance of the third capacitor, is less than the third value.
